(19) United States
(12) Patent Application Publication
(10) Pub. No.: US 2015/0264320 A1
(43) Pub. Date: Sep. 17, 2015

(54) VIDEO PROCESSING APPARATUS AND VIDEO PROCESSING METHOD

(71) Applicant: NEC Corporation, Tokyo (JP)

(72) Inventor: Masato YUKI, Tokyo (JP)

(21) Appl. No.: 14/658,663

(22) Filed: Mar. 16, 2015

(30) Foreign Application Priority Data
Mar. 14, 2014 (JP) 2014-052092

(51) Int. Cl. H04N 7/18; H04N 5/232; G08B 13/196

(52) U.S. Cl. CPC H04N 7/181; G08B 13/19656; G08B 13/19663; H04N 5/23206

(57) ABSTRACT

A video processing apparatus includes a video generation unit 1, a load measurement unit 2, and a frame rate control unit 3. The video generation unit 1 generates respective videos with a frame rate of a predetermined setting value based on respective video signals of a plurality of imaging devices input from the plurality of imaging devices over a network. The load measurement unit 2 measures a load when the video generation unit 1 performs a process of generating the videos. The frame rate control unit 3 updates the predetermined setting value based on a measurement result of the load by the load measurement unit 2, and controls the video generation unit 1 to generate the respective videos at the frame rate of the updated predetermined setting value.

This application is based upon and claims the benefit of priority from Japanese Patent Application No. 2014-052092, filed on Mar. 14, 2014, the disclosure of which is incorporated herein in its entirety by reference.

### TECHNICAL FIELD

The present invention relates to a video display technology, and more particularly, to a technology for simultaneously displaying a plurality of videos.

### BACKGROUND ART

There is widely used a video monitoring system in which cameras are installed at a plurality of places in traffic facilities, public facilities, factories, harbors and the like, videos are transmitted to one place over a network, and the videos are monitored in a centralized monitoring manner. There is a large scale video monitoring system including cameras installed at several thousands of places. When a monitoring center or the like at one place monitors videos by using a plurality of cameras, the videos may be monitored by selecting some of a plurality of videos and simultaneously displaying the selected videos on one screen.

Videos captured by a camera are transmitted over a network as video signals encoded in a predetermined manner. Therefore, in order to display the videos on a video display apparatus, the monitoring center and the like needs to decode the received video signals. Furthermore, particularly, in the case of observing in detail an object to be monitored such as the case of observing a place requiring high security, when video quality improvement is made, data processing amounts required in decoding may be enormous. Therefore, a video processing apparatus used in a video monitoring system for simultaneously displaying a plurality of videos is requested to have high video processing capability.

Since the video monitoring system is used for the detection of suspicious persons, the confirmation of safety, and the like, it needs to be operable continuously and stably. Furthermore, it is preferable that the video monitoring system can confirm each video in detail and has a high real-time property in video display. In this regard, it is necessary to raise a frame rate at the time of reproduction and display of each video to the maximum extent. However, in order to display a high quality video enabling detailed confirmation, when the frame rate of the video is raised, a processing amount becomes enormous and may exceed the amount of data which can be processed. When the amount of data which can be simultaneously processed by the video processing apparatus is exceeded, the monitoring of videos in the video monitoring system is hindered such as the stop of video display. Therefore, a technology for simultaneously displaying a plurality of videos on one screen while appropriately managing the frame rate and the like is important. A technology for simultaneously displaying a plurality of videos on a video display apparatus as one screen, for example, is disclosed in Patent Literature 1 (Japanese Laid-open Patent Publication No. 2010-213020).

Patent Literature 1 relates to a video monitoring system in which a video monitoring center connected over a network simultaneously displays videos captured by cameras installed at a plurality of bases on one screen. In the video monitoring system of Patent Literature 1, the camera and a video apparatus device are provided in each base in which videos are captured. In Patent Literature 1, videos are stored in the video apparatus device provided together with the camera, and stored each video data is transmitted to the video monitoring center. In the video monitoring center, a screen of one video display apparatus is divided, so that the videos transmitted from each base are simultaneously displayed on one video display apparatus.

Furthermore, in Patent Literature 1, when the videos captured by the camera in each base are stored in the video apparatus device, the number of frames to be stored is adjusted. In Patent Literature 1, video data of a certain frame and video data of a next frame are compared with each other, and data is stored only when there is a difference. Video data stored after the number of frames is reduced is read and is transmitted to the video monitoring center. In Patent Literature 1, such data storage is performed, so that it is possible to reduce the number of frames used in video reproduction and to shorten a time required for reproduction.

However, the technology of Patent Literature 1 is not sufficient in the following points. The video monitoring system needs to stably operate in order to continuously observe the movement and the like of an object to be monitored. In the technology of Patent Literature 1, preceding and subsequent frame are compared with each other, and the same frames are thinned out when they coincide with each other, so that the frame number is reduced. Therefore, when the object to be monitored continuously moves, since the difference of data increases in each frame, it is probable that frames which can be thinned out do not sufficiently exist. As a consequence, in the video monitoring system of Patent Literature 1, when monitoring an object and the like continuously moving, since a video data processing amount is increased and processing does not follow a video reproduction speed, so that reproduction of videos may be stopped or the system may be stopped. Accordingly, the technology of Patent Literature 1 is not sufficient as a technology for allowing a video monitoring system for observing an object to be monitored in detail in realtime to the maximum extent to operate continuously and stably.

Accordingly, an object of the present invention is to provide a video processing apparatus capable of continuously performing simultaneous display of a plurality of videos.

### SUMMARY

A video processing apparatus of the present invention includes a video generation unit, a load measurement unit, and a frame rate control unit. The video generation unit generates respective videos with a frame rate of a predetermined setting value based on respective video signals of a plurality of imaging devices input from the plurality of imaging devices over a network. The load measurement unit measures a load when the video generation unit performs a process of generating the videos. The frame rate control unit updates the predetermined setting value based on a measurement result of the load by the load measurement unit, and controls the video generation unit to generate the respective videos at the frame rate of the updated predetermined setting value.

A video processing method of the present invention generates respective videos with a frame rate of a predetermined setting value based on respective video signals of a plurality of imaging devices input from the plurality of imaging devices over a network. The video processing method of the present invention measures a load when a process of generating the videos is performed. The video processing method of the present invention controls the predetermined setting value to be updated based on a measurement result of the load, and the respective videos to be generated at the frame rate of the updated predetermined setting value.

### BRIEF DESCRIPTION OF THE DRAWINGS

Exemplary features and advantages of the present invention will become apparent from the following detailed description when taken with the accompanying drawings in which:

FIG. 1 is a diagram illustrating the overview of a configuration of a first exemplary embodiment;

FIG. 2 is a diagram illustrating the overview of a configuration of a second exemplary embodiment;

FIG. 3 is a diagram illustrating the overview of a configuration of a video display apparatus of the second exemplary embodiment;

FIG. 4 is a diagram illustrating an example of a data table of a second exemplary embodiment;

FIG. 5 is a diagram illustrating an example of a data table of the second exemplary embodiment;

FIG. 6 is a diagram illustrating an example of a data table of the second exemplary embodiment;

FIG. 7 is a diagram illustrating an example of setting of the second exemplary embodiment;

FIG. 8 is a diagram illustrating an example of setting of the second exemplary embodiment;

FIG. 9 is a diagram illustrating the overview of an operation flow in the second exemplary embodiment;

FIG. 10 is a diagram illustrating the overview of an operation flow in the second exemplary embodiment;

FIG. 11 is a diagram illustrating the overview of an operation flow in the second exemplary embodiment;

FIG. 12 is a diagram illustrating the overview of a configuration of a third exemplary embodiment;

FIG. 13 is a diagram illustrating the overview of a configuration of a video processing apparatus of the third exemplary embodiment;

FIG. 14 is a diagram illustrating an example of a data table of a third exemplary embodiment; and

FIG. 15 is a diagram illustrating the overview of an operation flow of the third exemplary embodiment.

### EXEMPLARY EMBODIMENT

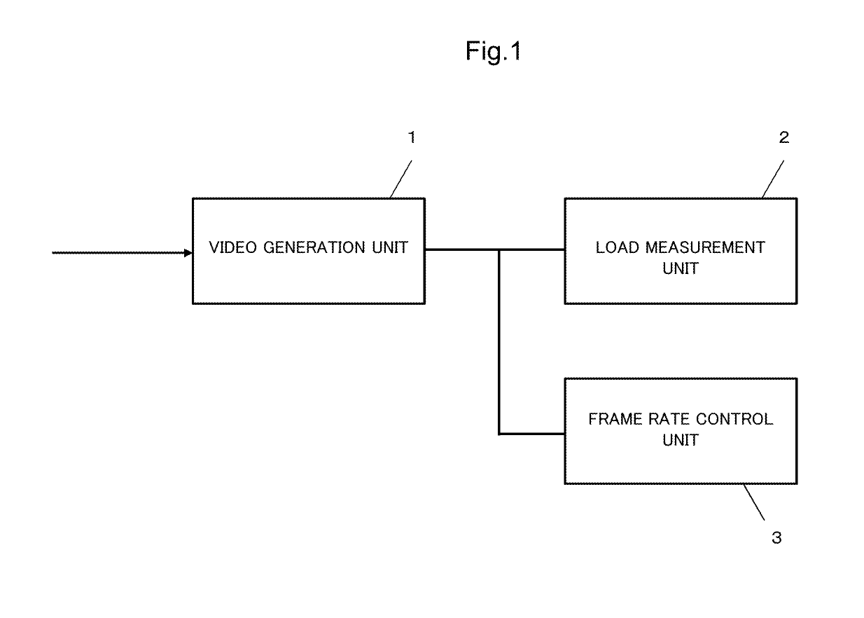

A first exemplary embodiment of the present invention will be described with reference to the accompanying drawing. FIG. 1 illustrates the overview of a configuration of a video processing apparatus of the present exemplary embodiment. The video processing apparatus of the present exemplary embodiment includes a video generation unit 1, a load measurement unit 2, and a frame rate control unit 3. The video generation unit 1 generates respective videos with a frame rate of a predetermined setting value based on respective video signals of a plurality of imaging devices input from the plurality of imaging devices over a network. The load measurement unit 2 measures a load when the video generation unit 1 performs a process of generating the videos. The frame rate control unit 3 updates the predetermined setting value based on a measurement result of the load by the load measurement unit 2, and controls the video generation unit 1 to generate the respective videos at the frame rate of the updated predetermined setting value.

In the video processing apparatus of the present exemplary embodiment, the load measurement unit 2 measures the load when the video generation unit 1 generates the videos. Furthermore, based on the measurement result of the load, the frame rate control unit 3 updates the setting value of the frame rate. In the video processing apparatus of the present exemplary embodiment, since the frame rate is updated in response to the load, it is possible to prevent a load of the video generation process from exceeding the capability of the apparatus. Therefore, in the video processing apparatus of the present exemplary embodiment, even though the video processing apparatus is operated in high quality setting, the frame rate is changed when a processing load is made heavy, so that it is possible to continuously perform video processing. As a consequence, the video processing apparatus of the present exemplary embodiment can continuously perform simultaneous display of a plurality of videos.

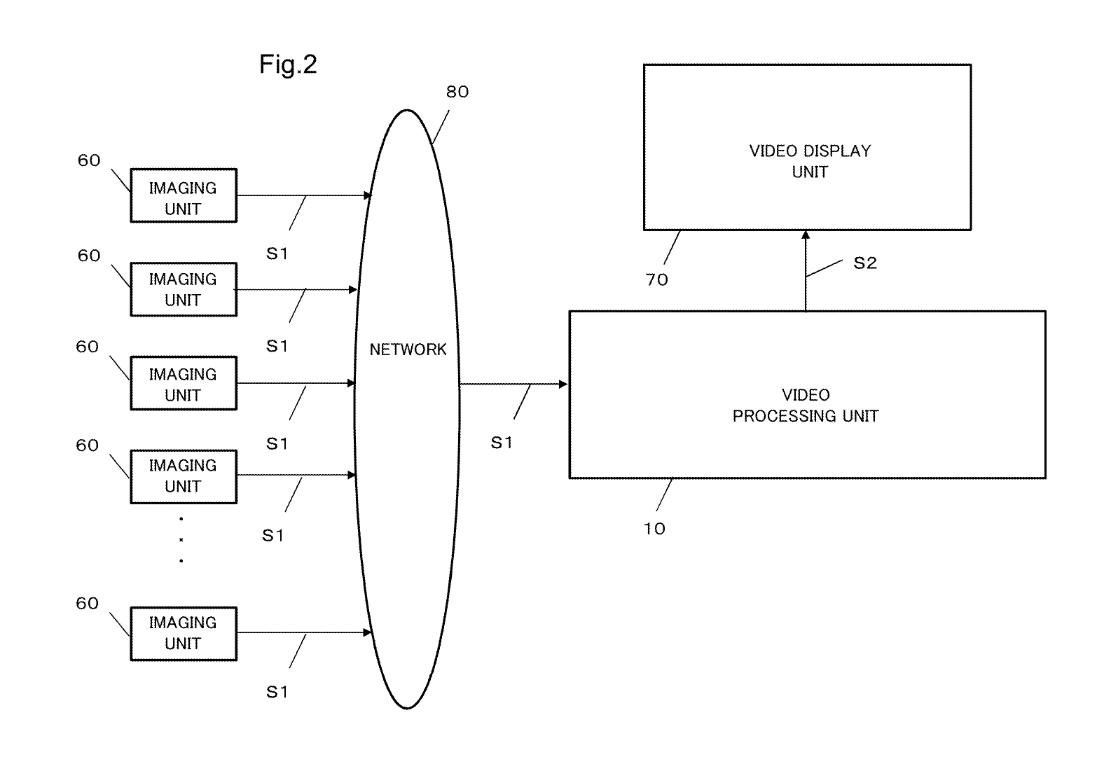

A second exemplary embodiment of the present invention will be described in detail with reference to the accompanying drawings. FIG. 2 illustrates the overview of a configuration of a video monitoring system of the present exemplary embodiment. The video monitoring system of the present exemplary embodiment includes a video processing unit 10, an imaging unit 60, and a video display unit 70. The imaging unit 60 is provided in a plural number, and each imaging unit 60 and the video processing unit 10 are connected to each other over a network 80. In the video monitoring system of the present exemplary embodiment, video data captured by the imaging unit 60 is transmitted to the video processing unit 10 as a video signal S1 for transmission. On the basis of the video signal S1 for transmission, the video processing unit 10 generates video data for displaying a video on the video display unit 70, and transmits the video data to the video display unit 70 as a video output signal S2. The video display unit 70 simultaneously displays a plurality of videos based on the video output signal S2.

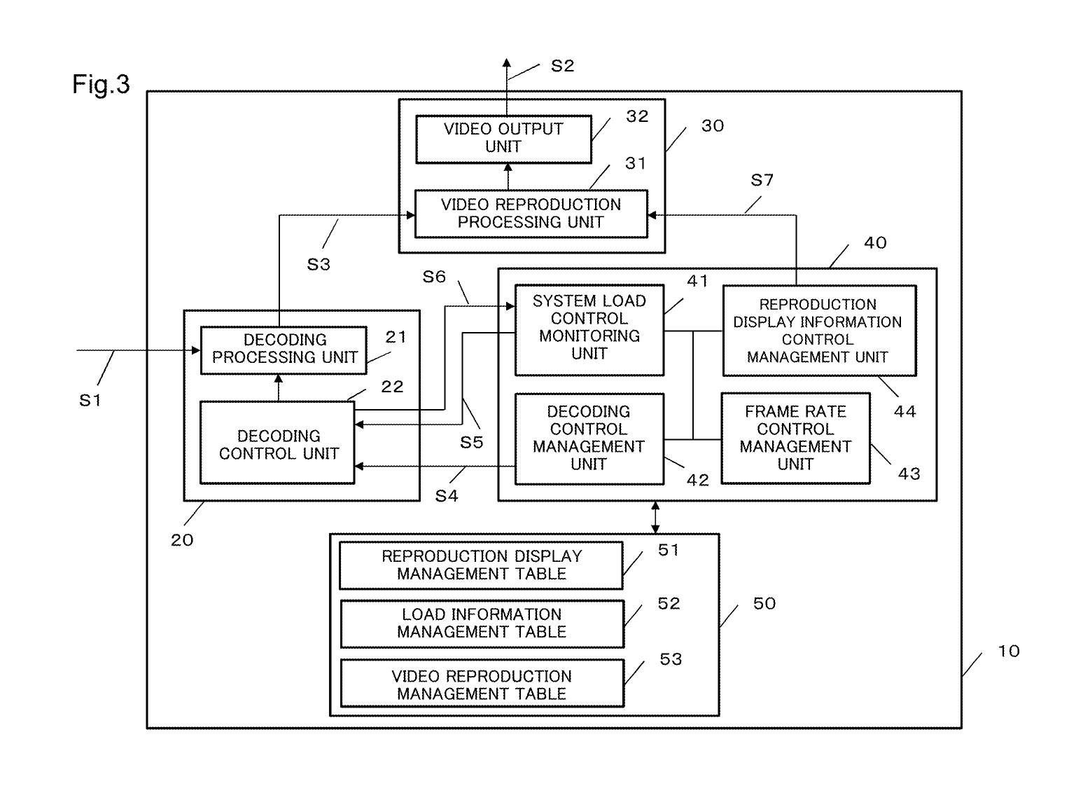

FIG. 3 is a diagram illustrating the overview of a configuration of the video processing unit 10. As illustrated in FIG. 3, the video processing unit 10 includes a video decoding processing unit 20, a video reproduction control unit 30, a video decoding setting management unit 40, and a data management unit 50.

The video decoding processing unit 20 includes a decoding processing unit 21 and a decoding control unit 22. The decoding processing unit 21 has a function of performing a decoding process for decoding the video signal S1 for transmission. The decoding processing unit 21 is configured by a plurality of CPUs (Central Processing Units) and a storage device. The decoding processing unit 21 performs the decoding process in a parallel manner on each video signal S1 for transmission corresponding to a camera ID set in a video reproduction management table 53. The assignment of a resource to each decoding process on each video signal S1 for transmission is controlled by the decoding control unit 22. Under the control of the decoding control unit 22, the decoding processing unit 21 performs the decoding process of the video signal S1 for transmission which is an object for the decoding process, and generates a video with a frame rate having a value set in the video reproduction management table 53.

Since the decoding process in the decoding processing unit 21 is performed in a parallel manner, when the total amount of data for performing the decoding process exceeds processing capability, the decoding process on a video with a high priority may be delayed or stopped. Therefore, in the video monitoring system of the present exemplary embodiment, when a high load state has been detected, a frame rate corresponding to the priority of each video is reviewed. The frame rate is updated in response to the priority, so that it is possible to continue the simultaneous display of a plurality of videos while maintaining the frame rate of a video with a high priority in the video monitoring system of the present exemplary embodiment.

The decoding processing unit 21 outputs the generated video data to a video reproduction processing unit 31 as a decoded video signal S3. The decoded video signal S3 is formed by information of video data and video IDs (IDentifications). The video ID is an identifier for identifying videos to be displayed on video display unit 70 from each other. In the video display unit 70, videos are displayed at positions corresponding to the video IDs. The decoding processing unit 21 may be configured as one device or may be configured by a plurality of devices such as a plurality of servers.

The decoding control unit 22 has a function of controlling the operation in which the decoding processing unit 21 generates the videos by the decoding processing. The decoding control unit 22 controls the operation of the decoding processing unit 21 on the basis of a video processing signal S4 transmitted from a decoding control management unit 42. The video processing signal S4 is formed by information of a camera ID as an identifier of the video signal S1 for transmission serving as an object of the decoding process, a setting value of a frame rate, and a video ID. The decoding control unit 22 designates the video signal S1 for transmission serving as an object of the decoding process and the frame rate, and controls the decoding process in the decoding processing unit 21. Furthermore, the decoding control unit 22 assigns resources such as the CPU and the like of the decoding processing unit 21 to the decoding process of data of each video signal S1 for transmission.

The decoding control unit 22 has a function of measuring the load of the decoding processing unit 21 in response to a load measurement signal S5 transmitted from a system load control monitoring unit 41. The decoding control unit 22 measures a load of an item designated to the load measurement signal S5, and transmits information of the measurement result to the system load control monitoring unit 41 as a measurement result signal S6. The measurement of the load is not performed in each decoding process of each video signal S1 for transmission, and is performed by measuring a load in the entire decoding process performed in a parallel manner.

The video reproduction control unit 30 includes the video reproduction processing unit 31 and a video output unit 32. The video reproduction processing unit 31 has a function of generating video data, by which the video display unit 70 displays videos, in response to the specifications of the video display unit 70. The specifications of the video display unit 70 indicate characteristics of the video display unit 70 such as a resolution and a color specification. The video reproduction processing unit 31 generates video data to be displayed by the video display unit 70 based on the decoded video signal S3, and transmits the generated video data to the video output unit 32. Furthermore, when a setting screen signal S7 is input, the video reproduction processing unit 31 generates image data of a setting selection screen and transmits the image data to the video output unit 32. The setting screen signal S7 is formed by video data for displaying information to be referred when a worker performs setting on the video display unit 70.

The video output unit 32 has a function of converting the video data received from the video reproduction processing unit 31 into a signal format conforming to a standard when the video data is transmitted to the video display unit 70, and outputs the converted signal. The video output unit 32 outputs the signal, which has been converted into the signal format to be transmitted to the video display unit 70, to the video display unit 70 as the video output signal S2. The video output signal S2 is transmitted to the video display unit 70 as a signal independent of each video data corresponding to a video ID. In the present exemplary embodiment, the video output unit 32 and to the video display unit 70 are connected to each other through video cables corresponding to the number of videos which can be simultaneously displayed. A plurality of video cables may be bundled into one and may be configured as one cable on external appearance. The video output unit 32 and to the video display unit 70 may also be connected to each other by a wireless communication scheme.

The video decoding setting management unit 40 includes the system load control monitoring unit 41, the decoding control management unit 42, a frame rate control management unit 43, and a reproduction display information control management unit 44.

The system load control monitoring unit 41 has a function of determining whether it is necessary to change a frame rate of each video based on the measurement result of a load situation of the video decoding processing unit 20. When measuring the load of the video decoding processing unit 20, the system load control monitoring unit 41 transmits a signal requiring the measurement of the load to the decoding control unit 22 as the load measurement signal S5. Furthermore, when information of a load measurement result is received as the measurement result signal S6, the system load control monitoring unit 41 compares the load measurement result with a predetermined reference and determines whether the video decoding processing unit 20 is in a high load state. The high load state indicates a state in which since an operating rate of the CPU and the like of the decoding processing unit 21 is high, when a video generation process is continued at the frame rate, it is highly probable that the processing capability is not sufficient.

The decoding control management unit 42 has a function of transmitting setting information on a video decoding process to the video decoding processing unit 20. The decoding control management unit 42 transmits a signal indicating the setting information on the video decoding process to the decoding control unit 22 as the video processing signal S4 with reference to the information of the video reproduction management table 53. The video processing signal S4 is formed by the information of the identifier of the video signal S1 for transmission serving as an object of the decoding process, the setting value of the frame rate, and the video ID.

The frame rate control management unit 43 has a function of deciding the setting value of the frame rate when the decoding processing unit 21 performs the decoding process. The frame rate control management unit 43 determines whether it is necessary to change the frame rate when the system load control monitoring unit 41 has detected the high load state of the decoding processing unit 21. Furthermore, when it is determined that the change of the frame rate is necessary, the frame rate control management unit 43 sets the value of the frame rate again and updates the video reproduction management table 53.

The reproduction display information control management unit 44 has a function of generating video data of a setting screen to be displayed on the video display unit 70 when performing the setting and the like of a reproduction display method are performed. The reproduction display information control management unit 44 transmits the generated video data of the setting screen to the video reproduction processing unit 31 as the setting screen signal S7.

The data management unit 50 has a function of storing each piece of information required for the operation of the video processing unit 10. The data management unit 50 stores information as a reproduction display management table 51, a load information management table 52, and the video reproduction management table 53.

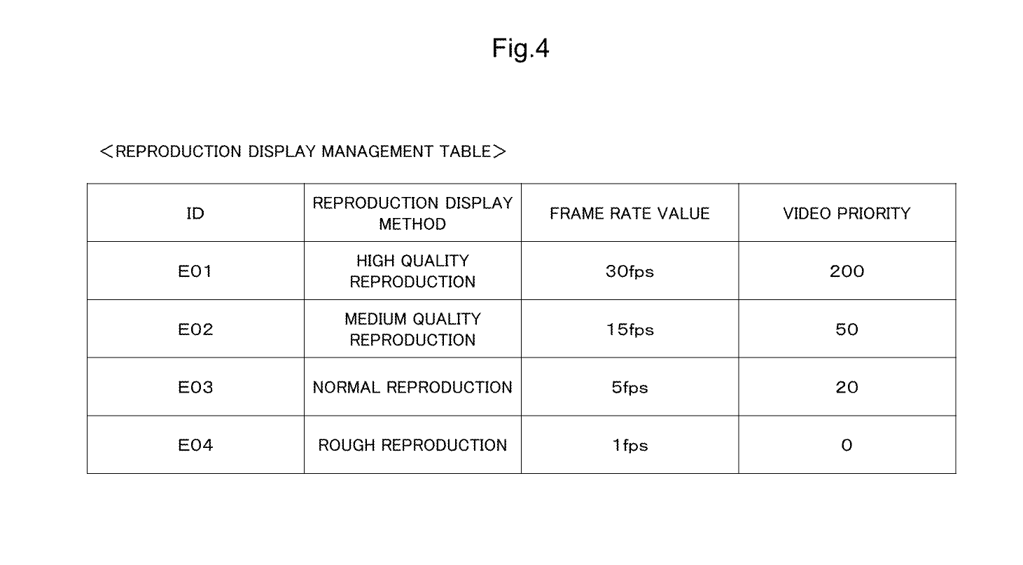

The reproduction display management table 51 is a data table for storing information of a video reproduction display method. The video reproduction display method indicates information and the like representing the image quality of a video to be displayed on the video display unit 70. FIG. 4 illustrates an example of the reproduction display management table 51 of the present exemplary embodiment. As illustrated in FIG. 4, the reproduction display management table 51 of the present exemplary embodiment is formed by information of four items of an ID, a reproduction display method, a frame rate value, and a video priority.

The ID of the reproduction display management table 51 is an abbreviation for a reproduction video display ID, wherein the reproduction video display ID indicates information of an identifier for identifying the video reproduction display method. The reproduction display method indicates information of a name of a reproduction display method. In the present exemplary embodiment, the reproduction display method is set in four stages of “high quality reproduction”, “medium quality reproduction”, “normal reproduction”, and “rough reproduction”, and names are set to each reproduction. The reproduction display method may further be set in a multi-stage, or may be set in three stages or less. The frame rate value indicates a value of a maximum frame rate when reproduction has been performed by each reproduction display method. The frame rate value is indicated as a maximum number of frames per second such as 30 fps. The video priority indicates information representing the priority of video display and is set corresponding to the reproduction display method. The video priority may be changed by a worker. The video priority of the present exemplary embodiment is set such that the priority is high as a numerical value increases.

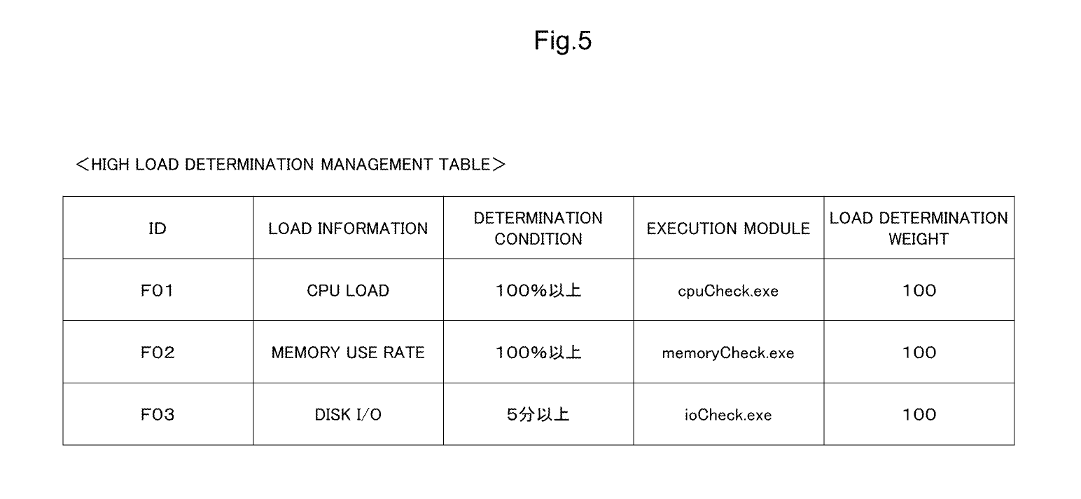

The load information management table 52 is a data table for storing information serving as a reference when determining the load of the decoding process in the decoding processing unit 21. FIG. 5 illustrates an example of a high load determination management table that is a data table stored as the load information management table 52. As illustrated in FIG. 5, the high load determination management table is formed by five items of an ID, load information, a determination condition, an execution module, and a load determination weight.

The ID of the high load determination management table is an abbreviation for a load information ID, wherein the load information ID indicates information of an identifier for identifying load information. The load information is information in which the content of load information has been indicated as a name. The load information represents an object of load determination. For example, a CPU load of the load information indicates a use rate of the CPU (Central Processing Unit) of the decoding processing unit 21. The determination condition indicates a reference for determining whether a load is high in each piece of load information. The execution module indicates a program name used when the load information is acquired. The load determination weight is a weighting value of each piece of load information when determining whether a load is high. A load determination weight of load determination, in which a measurement result is equal to or more than the reference of the determination condition, is added, and determination regarding whether a load is high is performed based on the total value.

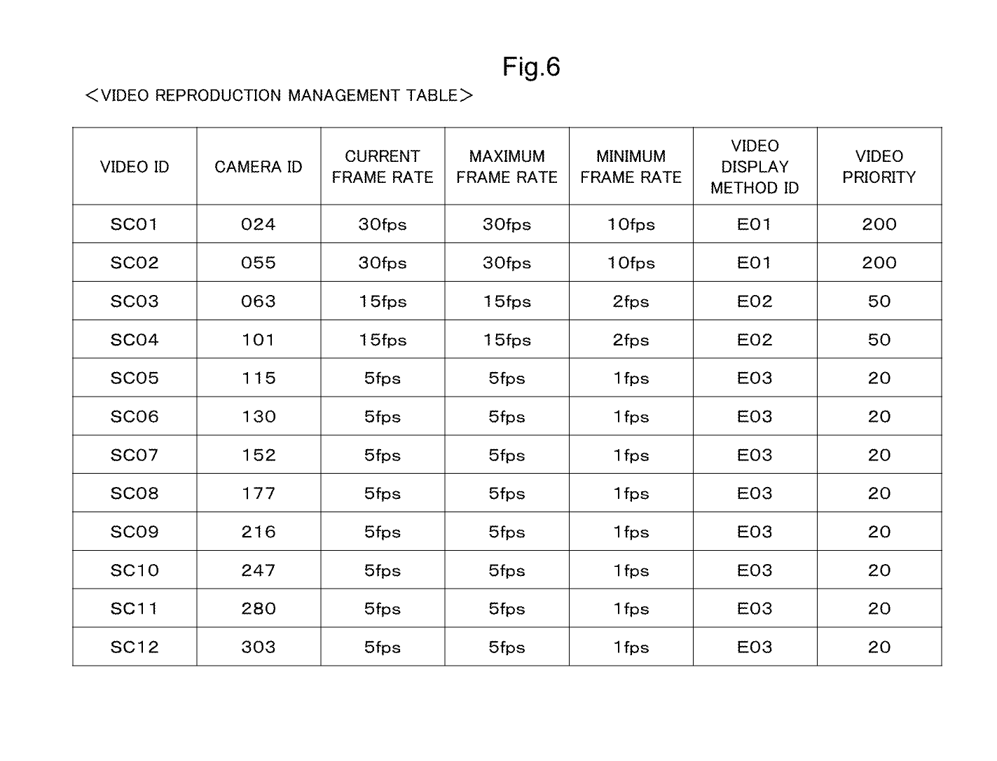

The video reproduction management table 53 is a data table for storing each piece of information required for reproducing videos. The video reproduction management table 53, for example, stores information of setting values when the decoding process is performed. FIG. 6 illustrates an example of a configuration of the video reproduction management table 53 of the present exemplary embodiment. As illustrated in FIG. 6, the video reproduction management table 53 of the present exemplary embodiment is formed by information of seven items of a video ID, a camera ID, a current frame rate, a maximum frame rate, a minimum frame rate, a video display method ID, and a video priority.

The video ID indicates information of an identifier of each section for displaying a plurality of videos when the plurality of videos are simultaneously displayed on the video display unit 70. The video reproduction management table 53 of FIG. 6 illustrates the case in which one screen is divided in 12 sub-screens and 12 videos are simultaneously displayed. Therefore, in the video reproduction management table 53, 12 types of video IDs are set.

The camera ID indicates information of an identifier for identifying the imaging units 60 having captured videos. In the example of FIG. 6, respective unique numbers are respectively assigned to the imaging units 60, so that it is possible to specify the imaging units 60 by using the unique numbers. Furthermore, the video signal S1 for transmission includes information of the camera ID.

The current frame rate indicates information of a setting value of a frame rate of a video corresponding to each video ID. The decoding processing unit 21 performs the decoding process to generate a video with a frame rate of the setting value of the current frame rate. The maximum frame rate indicates a maximum value of a setting range of the frame rate. The minimum frame rate indicates a minimum value of the setting range of the frame rate. In the present exemplary embodiment, the minimum frame rate is calculated by (maximum frame rate)×(video priority)/(sum of video priorities). That is, as the video priority is high, the value of the minimum frame rate is increased, resulting in the reduction of the number of frames which may be thinned out.

The video display method ID indicates information representing a selected reproduction display method indicated using the reproduction video display ID. The reproduction video display ID and the reproduction display method correspond to the reproduction display management table 51. The video priority indicates information representing the priority of a video corresponding to each video ID. By the magnitude of values of the video priority, an order in which the frame rate is increased and decreased is decided. In the present exemplary embodiment, a video having a large video priority value is set as a video with a high priority. Furthermore, a combination of the reproduction video display ID and the video priority of the video reproduction management table 53 of the present exemplary embodiment corresponds to the reproduction display management table 51.

Each imaging unit 60 has a function of imaging videos and has a function of performing an encoding process for coding the captured videos on the basis of a predetermined standard. The imaging unit 60 includes an imaging element for capturing videos. The imaging unit 60 codes the captured videos by the encoding process, and transmits video data to the video processing unit 10 over the network 80 as the video signal S1 for transmission. A unique camera ID has been assigned to each imaging unit 60. The imaging unit 60 adds information of the camera ID to the video signal S1 for transmission, and transmits video data with the added information to the video processing unit 10.

The video signals S1 for transmission transmitted from each imaging unit 60 are transmitted to the video processing unit 10 over the network 80. In the present exemplary embodiment, each video signal S1 for transmission is multiplexed in time division multiplexing by a relay apparatus provided in the network 80, and is transmitted to the video processing unit 10 as a multiplexed signal.

The imaging units 60 are installed at places where video monitoring is performed, such as traffic facilities, public facilities, factories, or harbor facilities. The imaging units 60 may be configured such that video capturing directions and conditions can be controlled from a remote place. Furthermore, a camera having a function of transmitting video data over a network, such as the imaging unit 60 of the present exemplary embodiment, is also called a network camera.

The video display unit 70 has a function of displaying videos based on the video output signal S2 transmitted from the video processing unit 10. As the video display unit 70, for example, a video display device such as a liquid crystal display device is available. The video display unit 70 can be configured by arranging a plurality of video display devices in a lattice shape. In the present exemplary embodiment, the video display unit 70 is configured by the total 12 video display devices arranged in three rows lengthwise and four rows breadthwise. Each display device displays a video with a corresponding video ID.

The network 80 is configured by an optical communication network, a wireless network and the like. The network 80 may also be configured by a plurality of types of combinations of the optical communication network, the wireless network and the like. Furthermore, the network 80 may also be configured by any one of a dedicated line and a shared line, or a combination of the dedicated line and the shared line. Furthermore, each imaging unit 60 may also be connected to a dedicated line independent of the video processing unit 10. It may be possible to a scheme in which the video signal S1 for transmission is multiplexed by a delay apparatus and the like on its way and is transmitted. Furthermore, the video signal S1 for transmission may also be transmitted in a packet method via the shred line such as the Internet or the dedicated line.

An operation of the video monitoring system of the present exemplary embodiment will be described. Firstly, an operation when the video processing unit 10 sets a video reproduction display method, that is, conditions in video display will be described.

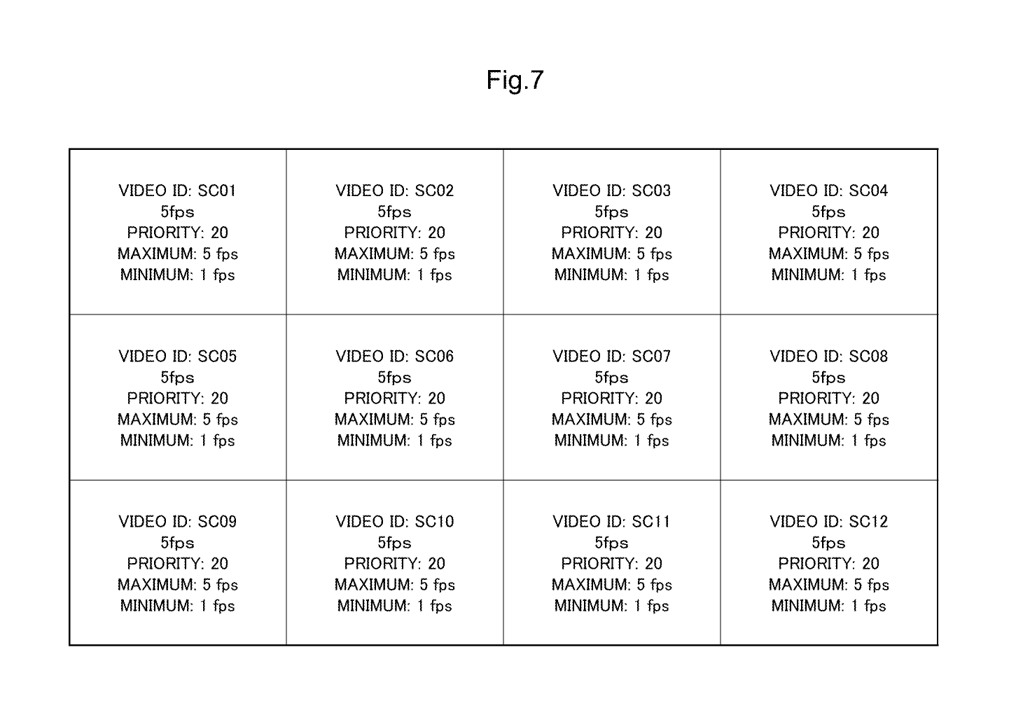

In the present exemplary embodiment, in an initial state, the following description will be given on the assumption that the setting of reproduction display as illustrated in FIG. 7 is made. FIG. 7 illustrates setting information of each section when the total 12 videos arranged in 3 sections in the longitudinal direction and four sections in the transverse direction are simultaneously displayed. In the initial setting of the setting of the video reproduction display method illustrated in FIG. 7, all the 12 videos displayed on one screen are set to normal reproduction. The setting content of the normal reproduction is stored in the reproduction display management table 51. In FIG. 7, the frame rate is set to 5 fps, the priority is set to 20, the maximum frame rate is set to 5 fps, and the minimum frame rate is set to 1 fps.

The reproduction display information control management unit 44 displays the videos as illustrated in FIG. 7 on the video display unit 70 via the video output unit 32. Firstly, a worker selects a reproduction display method of a section with a video ID of SC01 while seeing the screen display of the video display unit 70. When the reproduction display method of the section with the video ID of SC01 is selected, the reproduction display information control management unit 44 updates the information of the reproduction video display ID of the video reproduction management table 53. Furthermore, the reproduction display information control management unit 44 stores a value of a frame rate corresponding to the reproduction video display ID as values of the current frame rate and the maximum frame rate of the video reproduction management table 53 with reference to the reproduction display management table 51. Moreover, the reproduction display information control management unit 44 stores a value of a video priority corresponding to the reproduction video display ID as a value of the video priority of the video reproduction management table 53 with reference to the reproduction display management table 51.

When the setting of the reproduction display method of the section with the video ID of SC01 is performed, the setting of a reproduction display method for another section is subsequently performed. When the setting of the reproduction display method for all the 12 sections is ended, the reproduction display information control management unit 44 calculates a minimum frame rate corresponding to each video ID. When the minimum frame rate is calculated, the reproduction display information control management unit 44 stores the calculated value in the video reproduction management table 53. Furthermore, the setting of the reproduction display method may not be performed in sequence of video IDs, and may also be performed by selecting necessary video IDs and performing the setting only for the video IDs.

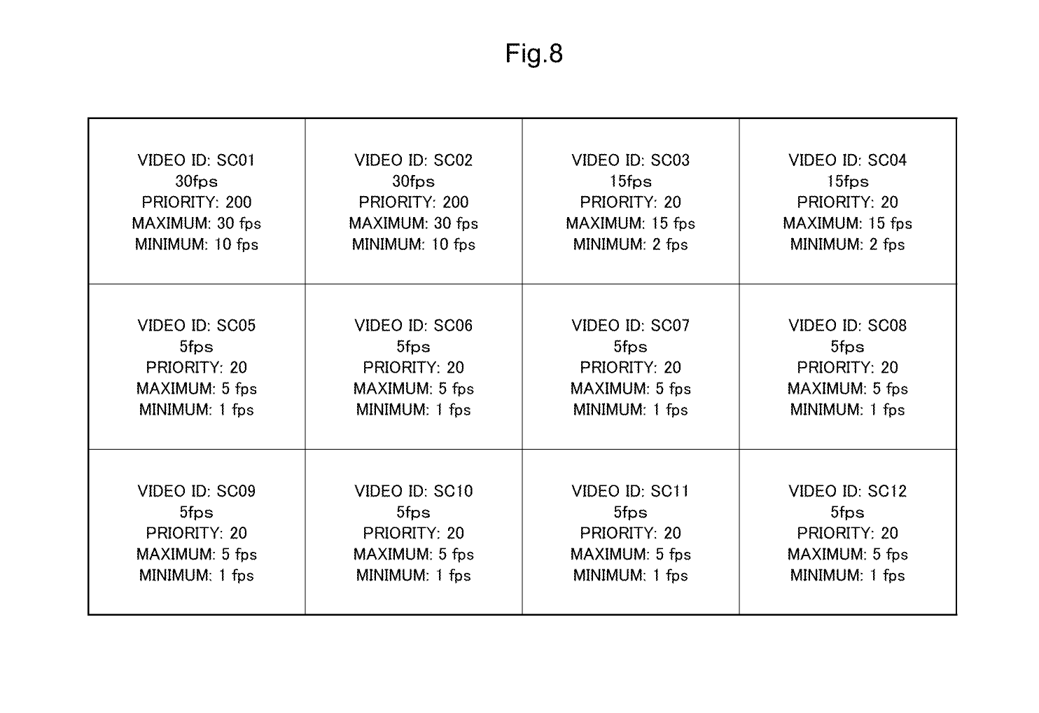

FIG. 8 illustrates the video reproduction management table 53 when the high quality reproduction has been selected for a section with a video ID of SC02, the medium quality reproduction has been selected for sections with video IDs of SC03 and SC04, and the normal reproduction has been selected for sections with video IDs of SC04 to SC12. In the example of FIG. 8, the maximum frame rate is 30 fps, the video priority is 200, and the sum of the video priorities of all the sections is 660. Thus, a minimum frame rate of sections with video IDs of SC01 and SC02 is calculated as 9.09 (30×200/660). The numerals after the decimal point are rounded up, so that 10 fps is set as the minimum frame rate of the sections of SC01 and SC02. Similarly, a minimum frame rate of sections with video IDs of SC03 and SC04 is calculated as 1.14 (15×50/660). The numerals after the decimal point are rounded up, so that 2 fps is set as the minimum frame rate of the sections of SC03 and SC04. A minimum frame rate of sections with video IDs of SC04 to SC12 is calculated as 0.15 (5×20/660). The numerals after the decimal point are rounded up, so that 1 fps is set as the minimum frame rate of the sections of SC04 to SC12.

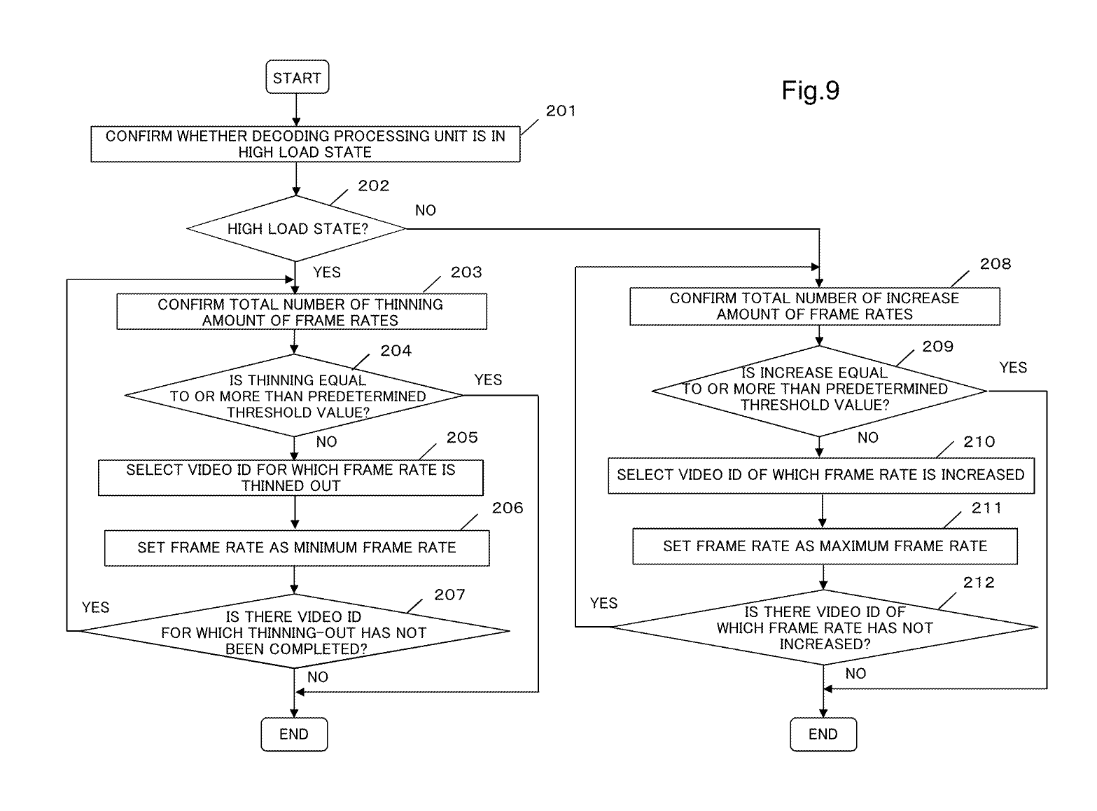

Next, an operation when the setting value of the frame rate is changed in video display on the video display unit 70 in the video monitoring system of the present exemplary embodiment will be described. FIG. 9 illustrates the overview of a flow when the change of the frame rate is performed.

By an operation by a worker or a predetermined timing, a review process of the frame rate is started. The predetermined timing, for example, is set as a constant time. When the review process of the frame rate is started, the system load control monitoring unit 41 confirms whether the decoding processing unit 21 is in a high load state (step 201). An operation when the system load control monitoring unit 41 confirms whether the decoding processing unit 21 is in a high load state will be described later.

When it is determined that the load exceeds a predetermined reference and reaches the high load state (Yes in step 202), the frame rate control management unit 43 confirms whether the total number of thinned-out frame rates has not exceed a predetermined threshold value (step 203). Immediately after the operation starts, the total number of thinned-out frame rates is 0. Furthermore, after the passage of a predetermined time and the like, when an operation for changing the frame rates is performed again, the total number is returned to 0 and the operation is performed. In the present exemplary embodiment, the predetermined threshold value is set to 30 fps. When the total number of thinned-out frame rates is equal to or more than the predetermined threshold value (Yes in step 204), the frame rate control management unit 43 determines that it is not possible to thin out frames and ends the operation for changing the frame rates.

When the total number of thinned-out frame rates is smaller than the predetermined threshold value (No in step 204), the frame rate control management unit 43 determines that it is possible to thin out frames and starts a frame thinning-out operation. Immediately after the operation starts, since the total number of thinned-out frame rates is 0, the determination result of step 204 is No.

When it is determined that it is possible to thin out frames, the frame rate control management unit 43 selects a video ID with the lowest video priority as a video ID of which the frame rate is reduced with reference to the video reproduction management table 53 (step 205). In the present exemplary embodiment, among video IDs with the current frame rates which are not the minimum frame rate, the video ID with the lowest video priority is selected as the video ID of which the frame rate is reduced. Furthermore, when candidates overlap each other, a video ID having the largest number is selected.

When the video ID of which the frame rate is reduced is selected, the frame rate control management unit 43 changes the current frame rate of the video ID to a value of the minimum frame rate (step 206). For example, when the video ID of SC12 is selected as an object of which the frame rate is reduced, the current frame rate of 5 fps is changed to the minimum frame rate of 1 fps. At this time, the number of thinned-out frame rates is 4.

When the value of the current frame rate is changed, the frame rate control management unit 43 confirms whether there is a video ID for which the thinning-out operation has not been completed. When there is the video ID for which the thinning-out operation has not been completed (Yes in step 207), the procedure returns step 203 and the thinning-out operation is continued.

When the thinning-out operation is continued, the frame rates are thinned out such that a number is reduced starting from the video ID of SC11. Subsequently, when the thinning-out is performed, the current frame rate is changed from 5 fps to 1 fps from SC05 to SC12 of the video IDs, so that the total number of the thinning-out is 28 fps. Moreover, the section with the video ID of SC04 is thinned out corresponding to 13 fps such that the current frame rate is changed from 15 fps to 2 fps by the thinning-out, so that the total number of the thinning-out is 41 fps. When the total number of the thinning-out exceeds the predetermined threshold value 30 fps, the determination result of step 204 is Yes and the frame rate thinning-out operation is ended. When the frame rate thinning-out operation is completed and the update of the video reproduction management table 53 is ended, the decoding process is performed at a new frame rate.

When it is determined that the load is smaller than the predetermined reference and does not reach the high load state (No in step 202), the frame rate control management unit 43 determines whether it is possible to raise the frame rate and to obtain high quality. In order to determine whether it is possible to raise the frame rate, the frame rate control management unit 43 confirms whether the total number of increased frame rates does not exceed a predetermined threshold value (step 208). In the present exemplary embodiment, the predetermined threshold value is set to 20 fps. Immediately after the operation starts, the total number of the increased frame rates is 0. Furthermore, after the passage of a predetermined time and the like, when the operation for changing the frame rates is performed again, the total number is returned to 0 and the operation is performed.

When the total number of the increased frame rates is equal to or more than the predetermined threshold value (Yes in step 209), the frame rate control management unit 43 determines whether an increase in the frame rates is not possible. When it is determined that an increase in the frame rates is not possible, the frame rate control management unit 43 ends the operation for changing the frame rates.

When the total number of the increased frame rates is smaller than the predetermined threshold value, the frame rate control management unit 43 determines that an increase in the frame rates is possible. When it is determined that an increase in the frame rates is possible, the frame rate control management unit 43 selects a video ID with the highest video priority as a video ID of which the frame rate is increased with reference to the video reproduction management table 53 (step 210). In the present exemplary embodiment, among video IDs with the current frame rates not reaching the maximum frame rate, information of the video ID with the highest video priority is selected. Furthermore, when candidates overlap each other, a video ID having the smallest number is selected.

When the video ID of which the frame rate is increased is selected, the frame rate control management unit 43 changes the current frame rate of the video ID to the value of the maximum frame rate (step 212). For example, when the section with the video ID of SC04 is selected as an object of which the frame rate is increased, the frame rate control management unit 43 increases the current frame rate from 2 fps to 15 fps, which is the maximum frame rate, by 13 fps.

When the frame rate is increased, it is confirmed whether there are video IDs of which the frame rates has not been completely increased. When there are no video IDs of which the frame rates has not been completely increased (No in step 212), the frame rate control management unit 43 ends the operation for changing the frame rates.

When there are the video IDs of which the frame rates has not been completely increased (Yes in step 212), the procedure returns to step 208 and the operation is performed until the total number of increased frame rates exceeds the predetermined threshold value. In the present exemplary embodiment, the frame rate control management unit 43 increases the current frame rates of the video IDs of SC05 and SC06 from 1 fps to 5 fps by 4 fps. When the current frame rate of the video ID of SC06 is increased, the total number of increased frame rates is 21 fps and exceeds the predetermined threshold value. When the total number of increased frame rates exceeds the predetermined threshold value, since the confirmation result of step 208 is No, frame rates of other video IDs are not changed.

When the operation for increasing the frame rates is completed and the update of the video reproduction management table 53 is ended, the decoding process is performed at a new frame rate. In this way, the operation for changing the frame rates is completed.

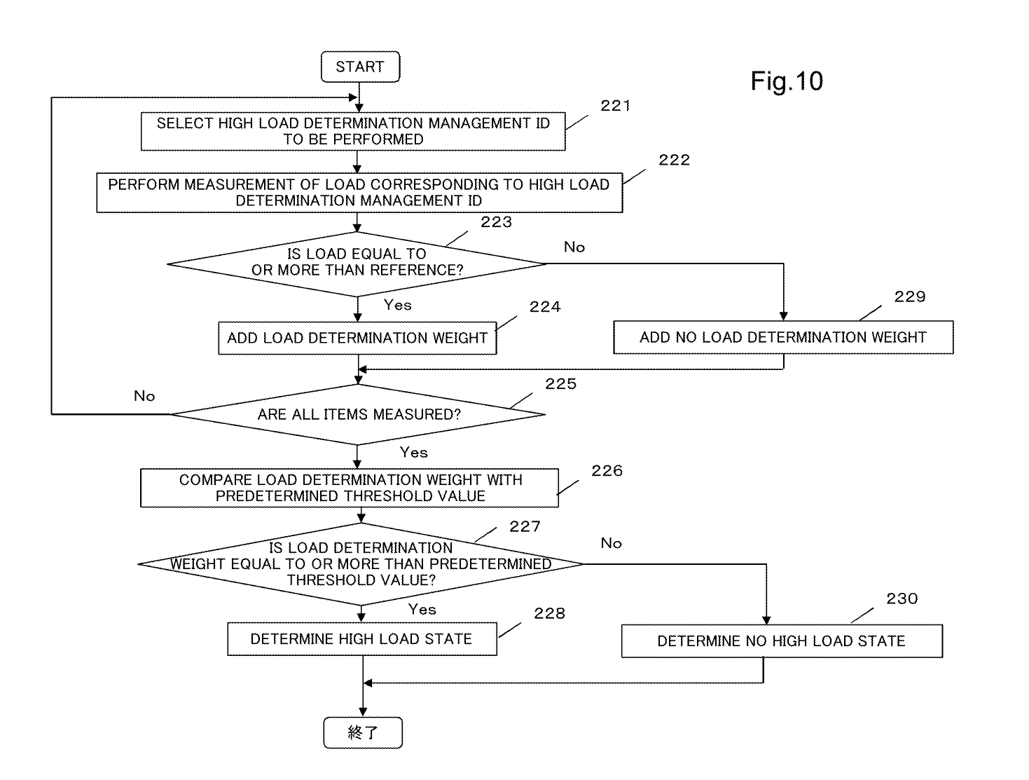

Next, an operation when it is determined whether the load of the decoding processing unit 21 is in the high load state will be described. FIG. 10 illustrates the overview of an operation flow when it is determined whether the decoding processing unit 21 is in the high load state.

When determination regarding whether the decoding processing unit 21 is in the high load state is started, the system load control monitoring unit 41 selects a high load determination management ID indicating an object of load measurement from the high load determination management table of the load information management table 52 (step 221). The high load determination management ID corresponds to a load measurement item, that is, load information. When the high load determination management ID is selected, the system load control monitoring unit 41 transmits a signal indicating information of an execution module corresponding to the high load determination management ID to the decoding control unit 22 as the load measurement signal S5. The decoding control unit 22 measures the load of the decoding processing unit 21 according to the information indicated by the load measurement signal S5 (step 222). For example, when F01 is selected as the high load determination management ID, the load measurement is performed by measuring the use rate of the CPU per a predetermined time. When the load measurement is ended, the decoding control unit 22 transmits a signal indicating a measurement result to the system load control monitoring unit 41 as the measurement result signal S6.

When the measurement result signal S6 is received, the system load control monitoring unit 41 compares the measurement result with the determination condition of the high load determination management table. When the measurement result satisfies the determination condition, that is, when the load is equal to or more than the predetermined reference (Yes in step 223), the system load control monitoring unit 41 adds a load determination weight (step 224). The load determination weight indicates weighting of a measurement result of each piece of load information in the case of calculating an evaluation value when a load situation is finally determined. The load determination weight is set such that as the value is large, the load is high. When the load determination weight is added, the system load control monitoring unit 41 confirms whether all the items of the high load determination management table have been measured. When all the items, that is, the load information has not been measured (No in step 225), the procedure returns to step 221 and the system load control monitoring unit 41 measures other items.

When the measurement of all the items has been ended (Yes in step 225), the system load control monitoring unit 41 compares the total number of the load determination weights with a predetermined threshold value. When the total number of the load determination weights is equal to or more than the predetermined threshold value (Yes in step 227), the system load control monitoring unit 41 determines that the decoding processing unit 21 is in the high load state (step 228). When the total number of the load determination weights are smaller than the predetermined threshold value (No in step 227), the system load control monitoring unit 41 determines that the decoding processing unit 21 is not in the high load state (step 230).

Furthermore, when the measurement result does not satisfy the determination condition in step 223, that is, when the load is smaller than the predetermined reference (No in step 223), the system load control monitoring unit 41 does not add the load determination weight (step 229). When the load is smaller than the predetermined reference, the load determination weight is not added and the processes from step 225 are performed. In this way, the operation when it is determined whether the load of the decoding processing unit 21 is in the high load state is completed.

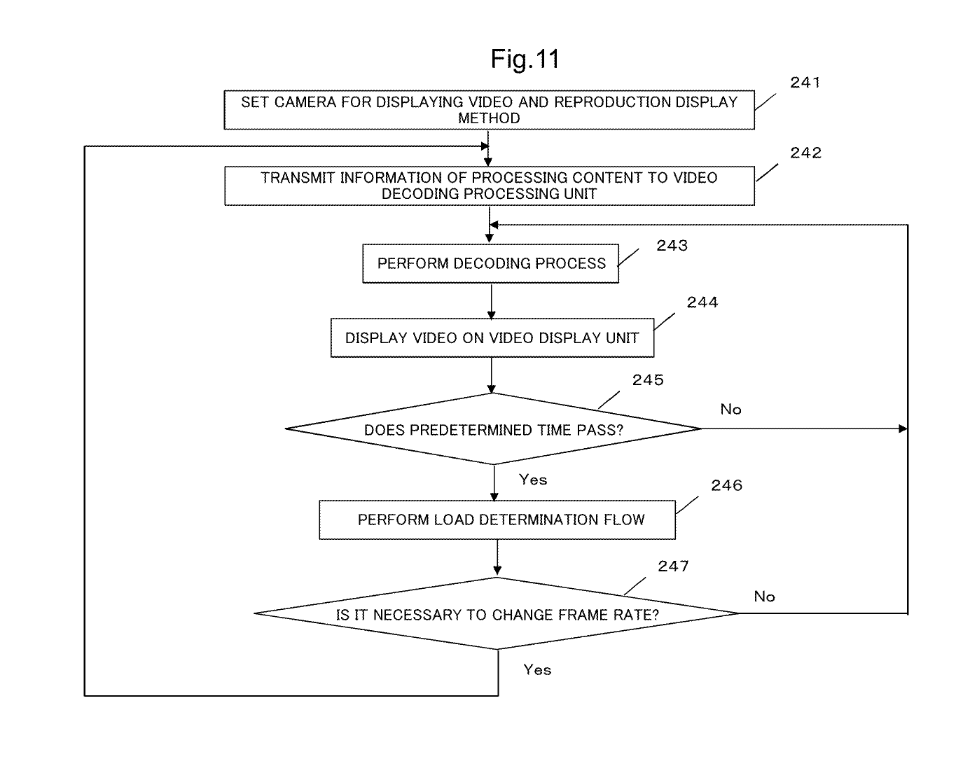

Next, an operation when a video captured by the imaging unit 60 is displayed on the video display unit 70 in the video monitoring system of the present exemplary embodiment will be described. FIG. 11 illustrates the overview of an operation flow when a video captured by the imaging unit 60 is displayed on the video display unit 70.

Firstly, a worker selects a predetermined number of imaging units 60 which are video display objects. Furthermore, a reproduction display method for each video is set (step 241). In the present exemplary embodiment, since 12 videos are simultaneously displayed, 12 imaging units 60 and reproduction display methods are selected. The number of the imaging units 60 selected as the video display objects may not be a maximum number of videos which can be simultaneously displayed on the video display unit 70. In the present exemplary embodiment, the imaging units 60 are selected by selecting corresponding video IDs.

When the reproduction display method is set, the frame rate control management unit 43 updates the information of the video reproduction management table 53. When the video reproduction management table 53 is updated, the decoding control management unit 42 transmits setting information of the decoding process to the video decoding processing unit 20 as the video processing signal S4 (step 242).

Images captured by each imaging unit 60 are coded by an encoder and are converted into video signals having a signal format conforming to a predetermined communication standard. The converted video signals are transmitted to the video processing unit 10 over the network 80 as the video signals S1 for transmission. Each video signal S1 for transmission is multiplexed in time division multiplexing by a relay apparatus provided in the network 80, and is transmitted to the video processing unit 10. Furthermore, the video signal S1 for transmission includes information of camera IDs uniquely assigned to each imaging unit 60.

The multiplexed video signal S1 for transmission input to the video processing unit 10 is divided into each video signal S1 for transmission in an input unit of the video processing unit 10 and is transmitted to the video decoding processing unit 20. Among the video signals S1 for transmission input to the video decoding processing unit 20, the decoding process is performed on a video signal S1 for transmission corresponding to the selected imaging unit 60 (step 243). Furthermore, the decoding process is performed on a plurality of selected video signals S1 for transmission in a parallel manner.

The decoding control unit 22 of the video decoding processing unit 20 controls the decoding process in the decoding processing unit 21 such that the frame rate indicated by the video processing signal S4 is obtained. The decoding processing unit 21 transmits each piece of video data generated by performing the decoding process to the video reproduction processing unit 31 as the decoded video signal S3.

The video reproduction processing unit 31 converts the decoded video signal S3 corresponding to each video ID into a signal corresponding to the specifications of the video display unit 70, and transmits the converted signal to the video output unit 32. The video output unit 32 transmits a signal received from the video reproduction processing unit 31 to the video display unit 70 as the video output signal S2 of each video ID. The video display unit 70 displays a video in a section corresponding to each video ID based on the received video output signal S2 (step 244).

When a video is displayed on the video display unit 70 and a predetermined time passes (Yes in step 245), the load determination flow for determining whether the decoding processing unit 21 is in the high load state is performed (step 246). The load determination flow for determining whether the decoding processing unit 21 is in the high load state is performed in flows from step 221 to step 230.

When a change of the frame rate has been performed (Yes in step 247), the procedure returns to step 242 and an operation based on a new frame rate is performed. When the change of the frame rate has not been performed (No in step 247), the procedure returns to step 243 and an operation in the current setting is continued. In this way, the operation when the video captured by the imaging unit 60 is displayed on the video display unit 70 is completed.

In the video monitoring system of the present exemplary embodiment, when the load state of the video decoding processing unit 20 is measured and the load is higher than the predetermined reference, a frame rate of a video with a low priority is lowered, so that the processing amount of the video decoding processing unit 20 is reduced. The frame rate of the video with the low priority is lowered, so that it is possible to maintain a frame rate of a video with a high priority, that is, an image quality. Furthermore, the frame rate of the video with the low priority is lowered, so that it is possible to continuously perform the display to the video display unit 70.

Even though the video monitoring system of the present exemplary embodiment starts to operate in high quality setting, when a load becomes high, the entire load is suppressed by lowering the frame rate of the video with the low priority. Therefore, in the video monitoring system of the present exemplary embodiment, the system is prevented from being stopped by maintaining processing at a frame rate according to setting at the time of operation start. As a consequence, in the video monitoring system of the present exemplary embodiment, it is possible to continuously perform simultaneously display of a plurality of videos while maintaining videos with a high priority to be observed in detail.

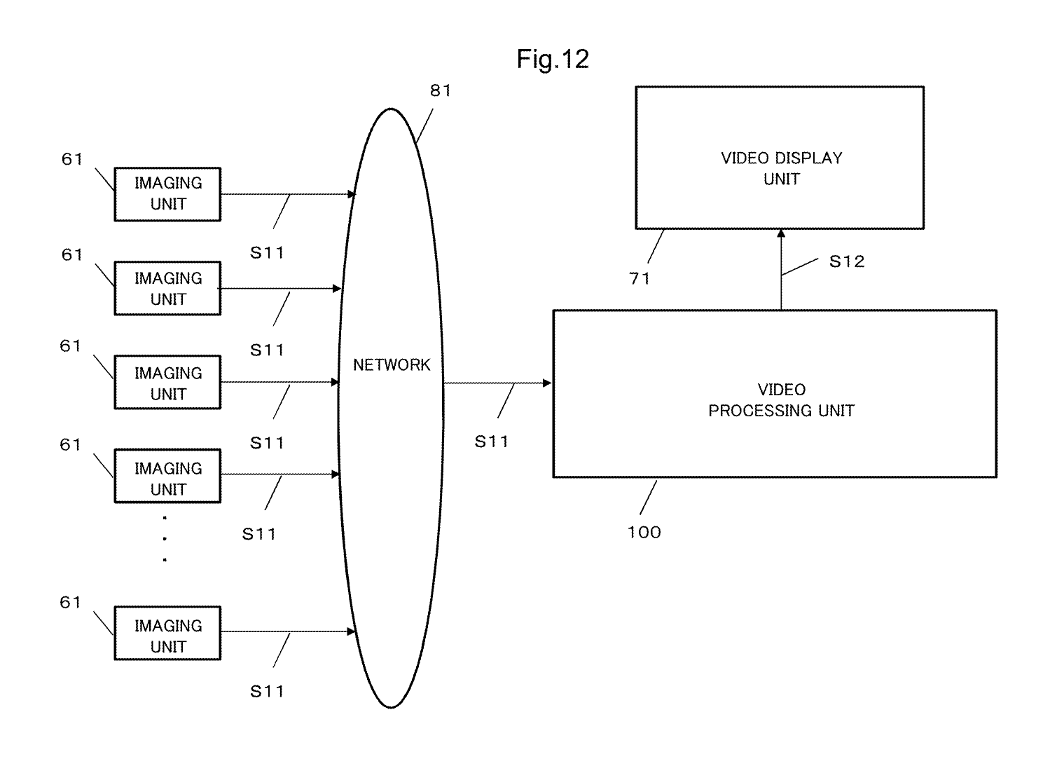

A third exemplary embodiment of the present invention will be described in detail with reference to FIG. 12. FIG. 12 illustrates the overview of a configuration of a video monitoring system of the present exemplary embodiment. In the second exemplary embodiment, a load state is measured in each predetermined time and the frame rate is reviewed. In the video monitoring system of the present exemplary embodiment, in addition to each predetermined time, a video analysis unit is provided, and a priority is changed when a predetermined image is detected and a frame rate change is performed.

As illustrated in FIG. 12, the video monitoring system of the present exemplary embodiment includes a video processing unit 100, imaging units 61, and a video display unit 71. The imaging units 61 are provided in a plural number, and each imaging unit 61 and the video processing unit 100 are connected to each other over a network 81. In the video monitoring system of the present exemplary embodiment, video data captured by the imaging unit 61 is transmitted to the video processing unit 100 as a video signal S11 for transmission. Based on the video signal S11 for transmission, the video processing unit 100 generates video data for displaying a video on the video display unit 71, and transmits the video data to the video display unit 71 as a video output signal S12. The video display unit 71 simultaneously displays a plurality of videos based on the video data of the video output signal S12.

The configurations and functions of the imaging unit 61, the video display unit 71, and the network 81 of the present exemplary embodiment are equal to those of the elements with the same names of the second exemplary embodiment. The video signal S11 for transmission and the video output signal S12 of the present exemplary embodiment are formed by information equal to that of the signals with the same names of the second exemplary embodiment. Furthermore, information constituting a decoded video signal S13, a video processing signal S14, a load measurement signal S15, a measurement result signal S16, and a setting screen signal S17 of the present exemplary embodiment and functions of each signal are equal to those of the signals with the same names of the second exemplary embodiment.

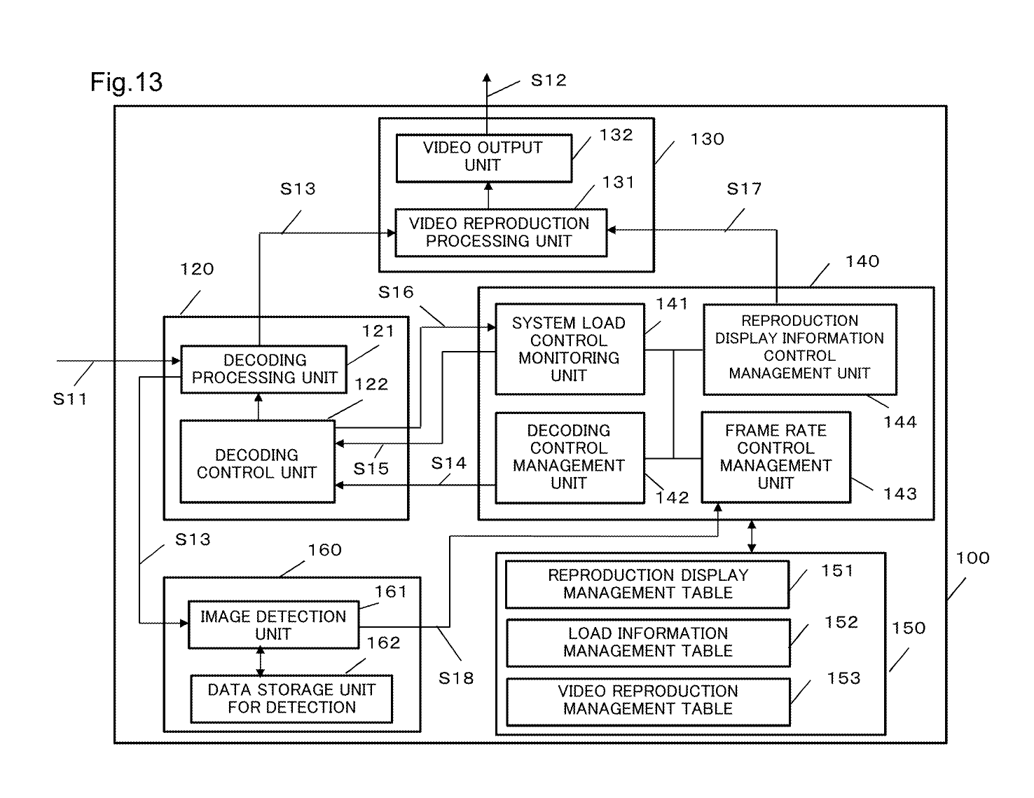

FIG. 13 illustrates the overview of a configuration of the video processing unit 100 of the present exemplary embodiment. As illustrated in FIG. 13, the video processing unit 100 includes a video decoding processing unit 120, a video reproduction control unit 130, a video decoding setting management unit 140, a data management unit 150, and a video analysis unit 160.

The video decoding processing unit 120 includes a decoding processing unit 121 and a decoding control unit 122. The configuration and function of the decoding control unit 122 are equal to those of the element with the same name of the second exemplary embodiment. The decoding processing unit 121 has a function of transmitting the decoded video signal S13 to an image detection unit 161 in addition to the same configuration and function as those of the element with the same name of the second exemplary embodiment.

The video reproduction control unit 130 includes a video reproduction processing unit 131 and a video output unit 132. The configurations and functions of the video reproduction processing unit 131 and the video output unit 132 are equal to those of the elements with the same names of the second exemplary embodiment.

The video decoding setting management unit 140 includes a system load control monitoring unit 141, a decoding control management unit 142, a frame rate control management unit 143, and a reproduction display information control management unit 144. The configurations and functions of the system load control monitoring unit 141, a decoding control management unit 142, and the reproduction display information control management unit 144 are equal to those of the elements with the same names of the second exemplary embodiment.

The frame rate control management unit 143 has a function of setting a frame rate again when an image detection signal S18 is received from the image detection unit 161, in addition to the same functions as those of the second exemplary embodiment. The image detection signal S18 is a signal indicating that a predetermined image has been detected from video data, and is formed by a video ID in which the predetermined image has been detected and information representing that the predetermined image has been detected. The predetermined image indicates an image coinciding with image data stored in a data storage unit 162 for detection such as a specific person and a suspicious person.

When the image detection signal S18 is received, the frame rate control management unit 143 updates an item of urgency of the video ID, in which the predetermined image has been detected, to information representing the presence of urgency. When the item of the urgency is updated, the frame rate control management unit 143 updates a video reproduction management table 153 such that a frame rate of the video ID, in which the predetermined image has been detected, becomes a maximum frame rate, on the basis of the image detection signal S18. Furthermore, the frame rate control management unit 143 updates the video reproduction management table 153 such that a frame rate of a video ID, in which the predetermined image has not been detected, becomes a minimum frame rate.

The data management unit 150 stores information as a reproduction display management table 151, a load information management table 152, and the video reproduction management table 153. The data configurations of the reproduction display management table 151 and the load information management table 152 are equal to those of the data tables with the same names of the second exemplary embodiment.

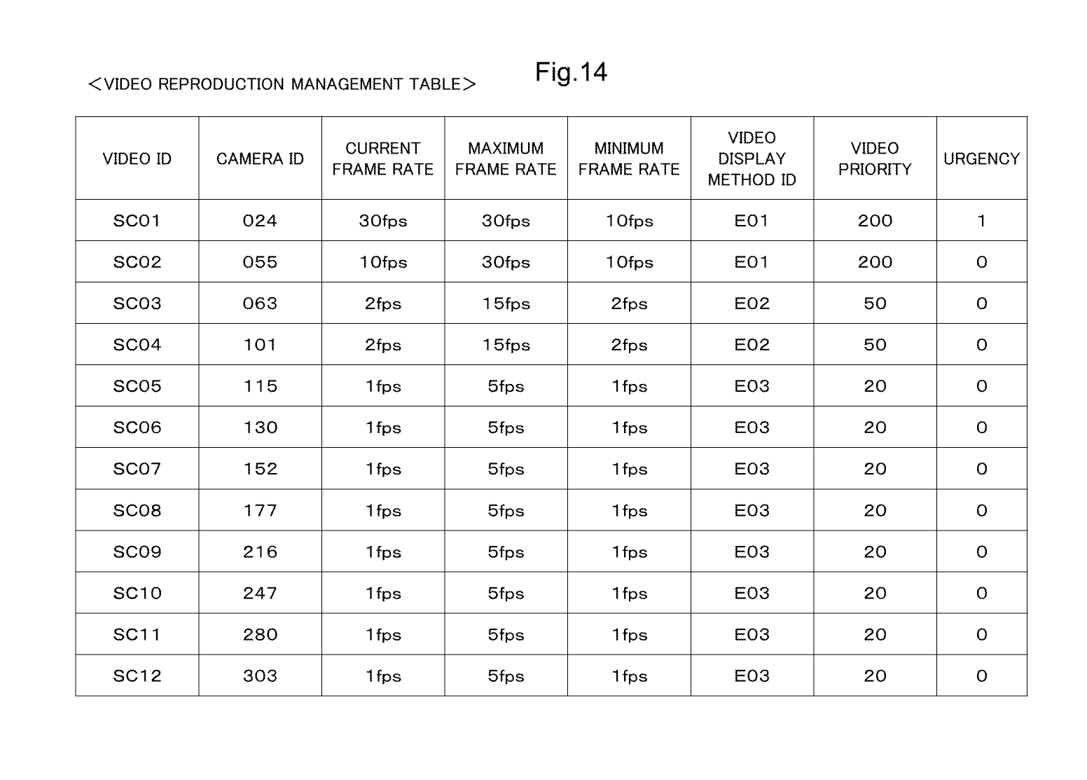

The video reproduction management table 153 stores information of urgency, in addition to the same items as those of the video reproduction management table of the second exemplary embodiment. The information of the urgency is stored as ‘1’ when there is urgency and is stored as ‘0’ when there is no urgency. FIG. 14 illustrates an example of an updated video reproduction management table 153 when the predetermined image has been detected from a video with a video ID of SC01. As illustrated in FIG. 14, the video reproduction management table 153 of the present exemplary embodiment stores the information of the urgency in addition to the same items as those of the second exemplary embodiment. In FIG. 14, the urgency of the video ID of SC01 is stored as ‘1’. Furthermore, in FIG. 14, for the video with the video ID of SC01, the current frame rate is set as a maximum frame rate, but frame rates of the other video IDs are set as a minimum frame rate.

In the present exemplary embodiment, as described above, frame rates of videos, other than the video with high urgency, are lowered, so that a processing load is reduced and the influence to the video with high urgency is suppressed. Therefore, a high load state, in which it is necessary to lower a frame rate of the video with high urgency, that is, a frame rate of a video from which a predetermined image has been detected, does not easily occur, and detailed observation can be continued. Furthermore, as described above, the frame rates of the other video IDs are uniformly lowered, so that it is possible to shorten a processing time required to set the frame rate again and thus a change to setting of a corresponding frame rate is possible immediately after the predetermined image is detected.

The video analysis unit 160 has a function of analyzing a video and detecting a predetermined image. The video analysis unit 160 includes the image detection unit 161 and the data storage unit 162 for detection. The image detection unit 161 has a function of detecting a predetermined image from the video data transmitted as the decoded video signal S13. The image detection unit 161 compares the video data with data stored in the data storage unit 162 for detection, and determines that the predetermined image is detected when the video data coincides with the data. When the predetermined image is detected from the video data, the image detection unit 161 transmits the image detection signal S18 to the frame rate control management unit 143. The predetermined image, for example, indicates an object such as a specific person and a vehicle. The image detection unit 161 may also be configured to detect a change in the number and movement of persons or objects. In the video monitoring system of the present exemplary embodiment, the predetermined image is set as an image with high priority of monitoring. Therefore, in order to enable detailed observation for a video corresponding to a video ID in which the predetermined image has been detected, the frame rate is raised or maintained and frame rates of other videos are lowered, so that video display is performed.

The data storage unit 162 for detection has a function of storing image data referred to when the image detection unit 161 detects the predetermined image. The data storage unit 162 for detection stores image data for reference. When the image detection unit 161 is configured to detect a change in the number and movement of persons or objects, the data storage unit 162 for detection stores reference data when detecting the change.

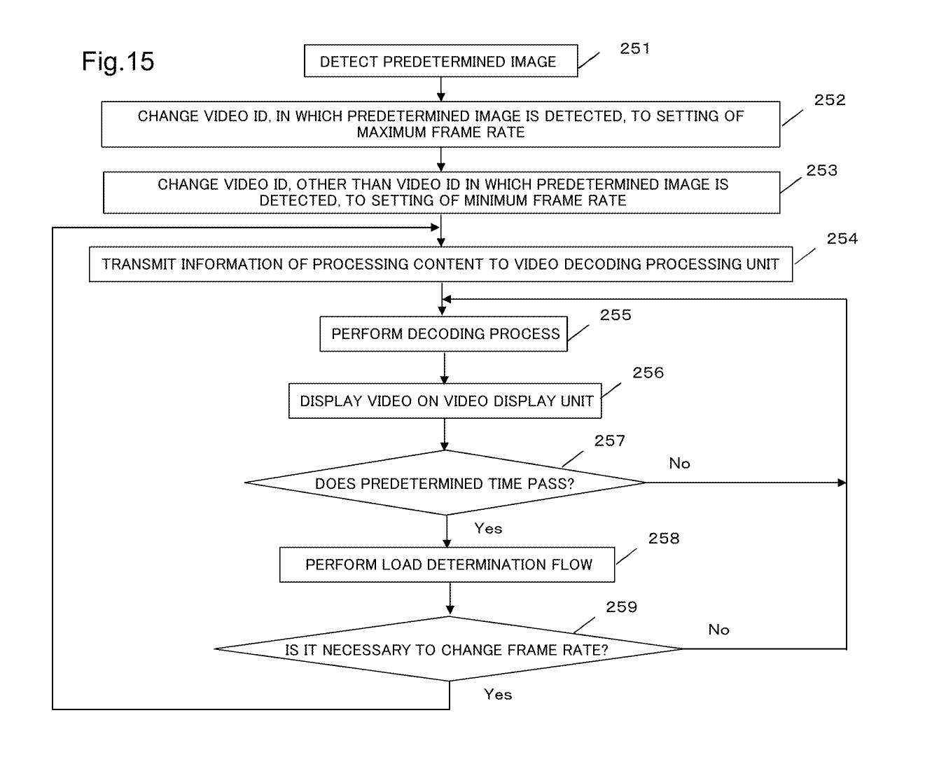

An operation of the video monitoring system of the present exemplary embodiment will be described. In the video monitoring system of the present exemplary embodiment, operations other than when the predetermined image has been detected are equal to those of the second exemplary embodiment. Therefore, in the video monitoring system of the present exemplary embodiment, the following description will be provided for only an operation for changing a frame rate when the predetermined image has been detected. FIG. 15 illustrates the overview of a flow when changing a frame rate when the predetermined image has been detected in the video monitoring system of the present exemplary embodiment.

The image detection unit 161 performs video monitoring by comparing an image of video data input from the decoding processing unit 121 with an image of the data storage unit 162 for detection. When the predetermined image is detected (step 251), the image detection unit 161 transmits the image detection signal S18 to the frame rate control management unit 143. The image detection signal S18 includes information of a video ID.

When the image detection signal S18 is received, the frame rate control management unit 143 changes a setting value of a current frame rate corresponding to the video ID of the video reproduction management table 153 to a value of the maximum frame rate (step 252). When the framer rate of the video ID designated by the image detection signal S18 is changed, the frame rate control management unit 143 changes setting values of current frame rates of other video IDs to be the minimum frame rate (step 253). When the video reproduction management table 153 is updated, the decoding control management unit 142 transmits information of a camera ID and a frame rate of each video ID to the decoding control unit 122 as the video processing signal S14 (step 254). When the video processing signal S14 is received, the decoding control unit 122 controls the decoding processing unit 121 to perform a decoding process at frame rates designated in each video ID by the video processing signal S14 (step 255). Video data decoded by the decoding processing unit 121 is transmitted to the video display unit 71 via the video reproduction control unit 130 as the video output signal S12. The video display unit 71 simultaneously displays a plurality of videos based on the video data of the video output signal S12 (step 256).

After a predetermined time passes (Yes in step 257), it is determined whether it is necessary to change frame rates. The video processing unit 100 determines whether it is necessary to change the frame rates by performing a load determination flow (step 258). When the frame rates have been changed (Yes in step 259), the frame rate control management unit 143 changes the frame rates and updates the video reproduction management table 153. When the video reproduction management table 153 is updated, the procedure returns to step 253 and a new setting value is transmitted to the decoding control unit 122 and a decoding process is performed with the new setting value. When the frame rates have not been changed (No in step 259), the procedure returns to step 255 and a decoding process with setting at that time point is continued.

Furthermore, when the predetermined time has not passed in step 257 (No in step 257), the procedure returns to step 255 and a decoding process with setting at that time point is continued. Furthermore, it may be possible to employ a configuration in which an operation for changing frame rates after a predetermined time passes is not performed. In such a configuration, the urgency of the video ID, in which the predetermined image has been detected, is set to be ‘no urgency’ by a worker and then the operation for changing frame rates is performed. Furthermore, when the predetermined image has been detected, a method for setting the predetermined time to be longer than usual may also be employed.

In the video monitoring system of the present exemplary embodiment, the frame rate of the video, in which the predetermined image has been detected, is raised to the maximum frame rate, and the video is displayed on the video display unit 71. Furthermore, for a video, in which the predetermined image has not been detected, the frame rate is lowered to the minimum frame rate. With such a configuration, when the predetermined image has been detected, it is possible to prevent the entire processing amount from being significantly increased while raising or maintaining the frame rate of the video, in which the predetermined image has been detected, without performing a complicated process. In the video monitoring system, in the case of observing in detail an image with high priority of observation which includes the predetermined image, it is less probable that the interruption and the like of the system occur due to the insufficiency of processing capability. Thus, in the video monitoring system of the present exemplary embodiment, it is possible to perform detailed observation of a video, in which the predetermined image has been detected, in realtime and to perform continuous display of other videos. As a consequence, in the video monitoring system of the present exemplary embodiment, it is possible to perform detailed observation of a video with high urgency and to continuously perform simultaneous display of a plurality of videos.

In the second exemplary embodiment and the third exemplary embodiment, the case in which a plurality of videos are simultaneously displayed on one screen has been described; however, the display destination of the videos may also be equal to or more than two screens.

In the third exemplary embodiment, the predetermined image is detected and a priority is changed. Instead of such a configuration, it may be possible to employ a configuration in which voice, temperature and the like are detected and a priority is changed. Furthermore, it may be possible to employ a configuration in which a change in the depth and the like of a river, which is different from the daily life, is detected and a priority is changed. When the voice, the temperature and the like are detected and the priority is changed, a configuration, in which a sensor is provided around an imaging device and voice and temperature information is transmitted to a video processing apparatus. When the temperature and the voice are smaller than a predetermined reference value or equal to or more than the reference value, the video processing apparatus changes the priority and sets a frame rate again. Furthermore, it may be possible to employ a configuration in which for a video of which the frame rate has been changed, display representing that the frame rate has been changed is displayed on the video processing apparatus. With such a configuration, it is possible to confirm in detail a video at a place where there has been a change in a state without special work.

Furthermore, instead of the configuration in which the predetermined image is detected and the priority is changed, it may be possible to employ a configuration in which the priority is changed when an imaging unit has made a predetermined movement. For example, when the direction, the slope, the zoom and the like of the imaging unit have been changed by an operation of a worker, the priority of a video is changed.

When the video processing apparatus or the video monitoring system of the first exemplary embodiment to the third exemplary embodiment is used in a scheme for performing video compression in units of groups of predetermined frames, the following can be made. As the scheme for performing the video compression in units of groups of frames, for example, there is a MPEG (Moving Picture Experts Group) scheme. In the MPEG scheme, video compression is performed in units of frames called GOP (Group of Picture). Therefore, when frames are reduced without employing the GOP as a unit, a problem may occur in video reproduction.

When the technologies of the first to third exemplary embodiments are used in such a compression scheme, the minimum frame rate is set as a value based on a setting value of the GOP. The minimum frame rate is made to be a multiple of the setting value of the GOP, and is set as a value approximating to 0. Furthermore, the maximum frame rate is also set to be the multiple of the setting value of the GOP. A frame rate when the decoding process is performed can be set as a value of the multiple of the setting value of the GOP between the minimum frame rate and the maximum frame rate. The frame rate is set as described above, so that a change in frame rates corresponding to the priority is possible without causing a problem in video reproduction even in a scheme in which video compression is performed in units of frames.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A video processing apparatus comprising:
a video generation unit that generates respective videos with a frame rate of a predetermined setting value based on respective video signals of a plurality of imaging devices input from the plurality of imaging devices over a network;
a load measurement unit that measures a load when the video generation unit performs a process of generating the videos; and
a frame rate control unit that updates the predetermined setting value based on a measurement result of the load by the load measurement unit, and controls the video generation unit to generate the respective videos at the frame rate of the updated predetermined setting value.

2. The video processing apparatus according to claim 1, further comprising:
a priority setting unit that sets a priority of a process in the video generation unit in the video signal input from the plurality of imaging devices,
wherein, when the load is higher than a predetermined reference, the frame rate control unit updates the predetermined setting value such that a frame rate of the video signal with low priority is lowered.

3. The video processing apparatus according to claim 2,
wherein, when the load is lower than the predetermined reference, the frame rate control unit updates the predetermined setting value such that the frame rate of the video signal with high priority is raised.

4. The video processing apparatus according to claim 1,
wherein the load measurement unit measures a load when the video generation unit performs a process of generating the videos, with respect to a plurality of items.

5. The video processing apparatus according to claim 1, further comprising
an image detection unit that detects a predetermined image from the video generated by the video generation unit,
wherein, when the image detection unit has detected the predetermined image, the frame rate control unit that updates the predetermined setting value such that a frame rate of a video, other than the video in which the predetermined image has been detected, is lowered.

6. A video monitoring system comprising:
a plurality of imaging devices;
the video processing apparatus according to claim 1; and
a video display apparatus,
wherein a video signal output from the imaging devices is input to the video display apparatus, and the video display apparatus displays a video generated by the video processing apparatus.

7. A video processing method comprising:
generating respective videos with a frame rate of a predetermined setting value based on respective video signals of a plurality of imaging devices input from the plurality of imaging devices over a network;
measuring a load when a process of generating the videos is performed;
updating the predetermined setting value based on a measurement result of the load; and
generating the respective videos at the frame rate of the updated predetermined setting value.

8. The video processing method according to claim 7,
wherein a priority of a process is set in the video signal input from the plurality of imaging devices, and
when the load is higher than a predetermined reference, the predetermined setting value is updated such that a frame rate of the video signal with low priority is lowered.

9. The video processing method according to claim 8,
wherein, when the load is lower than the predetermined reference, the predetermined setting value is updated such that the frame rate of the video signal with high priority is raised.

10. The video processing method according to claim 7,
wherein a predetermined image is detected from the generated video, and
when the predetermined image has been detected, the predetermined setting value is updated such that a frame rate of a video, other than the video in which the predetermined image has been detected, is lowered.
